(19) United States
(12) Patent Application Publication
(10) Pub. No.: US 2017/0009039 A1
(43) Pub. Date: Jan. 12, 2017

(54) MASTERBATCH AND APPLICATIONS THEREOF

(71) Applicant: MATSUMOTO YUSHI-SEIYAKU CO., LTD., Yao-shi (JP)

(72) Inventors: Takumi EBE, Yao-shi (JP); Katsushi MIKI, Yao-shi (JP)

(73) Assignee: MATSUMOTO YUSHI-SEIYAKU CO., LTD., Yao-shi (JP)

(21) Appl. No.: 15/116,383

(22) PCT Filed: Jan. 30, 2015
(86) PCT No.: PCT/JP2015/052628

§ 371 Date: Aug. 3, 2016

(30) Foreign Application Priority Data
Feb. 4, 2014 (JP) 2014-019121

(51) Int. Cl. C08J 9/32; C08L 101/00; C08L 33/08

(52) U.S. Cl. CPC C08J 9/32; C08L 33/08; C08L 101/00; C08J 2201/024; C08J 2203/22; C08J 2333/08; C08L 2310/00

(57) ABSTRACT

A masterbatch containing an organic base component and heat-expandable microspheres including a thermoplastic resin shell and a thermally vaporizable blowing agent encapsulated therein. The organic base component has a melting point not higher than the expansion-initiation temperature of the heat-expandable microspheres and a melt flow rate (MFR, g/10 mm) higher than 50 and not higher than 2200. A ratio of the heat-expandable microspheres ranges from 30 to 80 wt % of the total weight of the heat-expandable microspheres and the organic base component. Also disclosed is a molding composition, a foamed molded article manufactured by molding the molding composition and a weathers tripping.

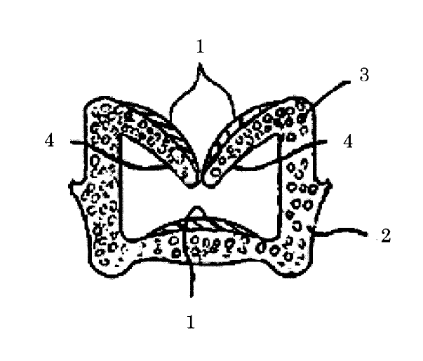

### CROSS-REFERENCE TO RELATED APPLICATIONS

This application is a National Stage of International Application No. PCT/JP2015/052628 filed Jan. 30, 2015, claiming priority based on Japanese Patent Application No. No. 2014-019121 filed Feb. 4, 2014, the contents of all of which are incorporated herein by reference in their entirety.

### BACKGROUND OF THE INVENTION

1. Field of the Invention

The present invention relates to a masterbatch and applications thereof.

2. Description of the Related Art

Foamed articles such as films, sheets and injection-molded products have been manufactured from a mixture of resin pellets and expandable components such as heat-expandable microspheres and expandable chemicals. Those expandable components are apt to disperse in the air and sometimes separate from the resin pellet mixtures while being fed to molding machines. This property of the expandable components causes insufficient dispersion of the expandable components in the mixtures, nonuniform, foaming and impaired strength of resultant foamed articles.

For solving these problems, resin pellets and expandable components are usually kneaded at a temperature higher than the softening temperature of the resin pellets and lower than the expansion temperature of the expandable components to obtain pelletized masterbatdb.es containing the expandable components, such as heat-expandable microspheres.

For example, patent document 1 discloses a masterbatch which comprises, as a base component, a polyethylene resin composition made of a polyethylene resin and polyethylene wax having a MW of 3000 or less, and heat-expandable microcapsules. Unfortunately, the polyethylene resin composition has an extremely low melt viscosity due to a high amount of the low-molecular-weight polyethylene wax contained therein. Also, such a polyethylene resin composition exhibits poor handling properties in premixing of the resin composition and the heat-expandable microcapsules. This is because a considerable amount of the premix adheres on the processing tools.

Patent document 2 discloses a masterbatch which comprises, as a base component, a thermoplastic resin having a melting point of 100° C. or higher, and heat-expandable microspheres. In preparing the masterbatch, the thermoplastic resin is melted by heating at a temperature around the expansion-initiation temperature of the heat-expandable microspheres, and the heat-expandable microspheres sometimes expand in the preparation process. Although the thermoplastic resin can be melted at a lowest possible temperature around its melting point to prevent expansion of the heat-expandable microspheres, such a resin has a high melt viscosity and causes difficulty in processing.

In addition, the masterbatch manufactured around the melting point of the thermoplastic resin cannot be well dispersed in a soft resin used for sealing materials, and the combination of the masterbatch and resin cannot be manufactured into sufficiently lightweight foamed molded articles. In particular, fine-particle heat-expandable microspheres in the masterbatch result in poor dispersion in resins to impart a poor lightweight effect to the resultant foamed molded articles.

[Patent Document 1] IP 2009-144122A

[Patent Document 2] WO 2010/038615 A1

### SUMMARY OF THE INVENTION

It is therefore an objection of the present invention to provide a masterbatch which exhibits good handling properties and can be processed into lighter foamed molded articles, and applications thereof:

Upon diligent investigation, the present inventors found that the above problems of the related art could be solved by employing a masterbatch comprising an organic base component having properties within specific ranges, to thereby achieve the present invention.

That is, the above object of the present invention has bene achieved by providing (1) a masterbatch comprises heat-expandable microspheres comprising a thermoplastic resin shell and a thermally vaporizable blowing agent encapsulated therein, and an organic base component. The organic base component has a melting point not higher than the expansion-initiation temperature of the heat-expandable microspheres and a melt flow rate (MFR, g/10 mm) higher than 50 and not higher than 2200. The ratio of the heat-expandable microspheres in the masterbatch ranges from 30 to 80 wt % of the total weight of the heat-expandable microspheres and the organic base component.

Preferred embodiments of the masterbatch of the present invention may meet at least one of the requirements (A) to (G) mentioned below.

(A) The organic base component is an ethylenic polymer, and a ratio of ethylene monomer to all monomers constituting the ethylenic polymer is at least 60wt %.

(B) The organic base component has a melting point ranging from 45 to 180° C.

(C) The organic base component has a tensile fracture stress not higher than 30 MPa.

(D) The thermoplastic resin is produced by polymerizing a polymerizable component containing a nitrile monomer.

(E) The polymerizable component further contains a carboxyl-group-containing monomer.

(F) The total weight of the carboxyl-group-containing monomer and the nitrile monomer is at least 50 wt % of the monomer component.

(G) The expansion-initiation temperature of the heat-expandable microsphere is at least 60° C.

In a second aspect (2), a molding composition of the present invention comprises the masterbatch and a matrix component. The matrix component preferably comprises a thermoplastic elastomer.

In a third aspect (3), a foamed molded article of the present invention is manufactured by molding the molding composition.

In a fourth aspect (4), a weatherstripping for an automobile or for a building of the present invention is manufactured by molding the molding composition.

### Advantageous Effects of the Invention

The masterbatch of the present invention has good handling properties and contributes to the manufacture of foamed molded articles having an improved lightweight effect.

The molding composition of the present invention can be manufactured into foamed molded articles having an improved lightweight effect owing to the masterbatch.

The foamed molded article of the present invention is lighter than similar conventional articles.

### BRIEF DESCRIPTION OF THE DRAWINGS

The figure is a cross-sectional view showing an example of an automotive weatherstripping according to the present invention.

### REFERENCE NUMERALS

Reference numerals used to identify various features of the drawings include the following.
1. Contact point to a windowpane
2. Thermoplastic elastomer
3. Hollow particles
4. Drain

### DESCRIPTION OF THE PREFERRED EMBODIMENTS

The invention will next be described with reference to the drawing. However, the present invention should not be construed as being limited thereto.

The masterbatch of the present invention contains heat-expandable microspheres and an organic base component. The components are described in detail as follows.

### Heat-Expandable Microspheres

The heat-expandable microspheres comprise a thermoplastic resin shell and a thermally vaporizable blowing agent encapsulated therein.

The mean particle size of the heat-expandable microspheres is not specifically restricted, and preferably ranges from 1 to 60 μm, more preferably from 2 to 40 μm, further more preferably from 3 to 30 μm, yet further more preferably from 5 to 20 μm, and most preferably from 6 to 13 μm. Heat-expandable microspheres having a mean particle size less than 1 μm may have poor expansion performance. The heat-expandable microspheres having a mean particle size greater than 60 μm may be expanded into excessively large bubbles in the foamed molded article to thereby deteriorate the strength of the article.

The coefficient of variation, CV, of the particle size distribution of the heat-expandable microspheres, is not specifically restricted, and preferably is not more than 35%, more preferably not more than 30%, and most preferably not more than 25%. The coefficient of variation, CV, can be calculated by the following mathematical expressions (1) and (2).

$$\begin{matrix}[ Math . 1 ] & \\ CV = ( s / 〈 x 〉 ) \times 100 ( \% ) & ( 1 ) \\ s = {\{ {\sum }_{i = 1}^{n} {( xi - 〈 x 〉 )}^{2} / ( n - 1 ) \}}^{1 / 2} & ( 2 )\end{matrix}$$

(where s is a standard deviation of the particle size of the microspheres, <x> is a mean particle size of the microspheres, “xi” is the particle size of the i-th particle, and n represents the number of particles)

The expansion-initiation temperature (Ts) of the heat-expandable microspheres is not specifically restricted, and preferably ranges from 60 to 250° C., more preferably from 70 to 230° C., further more preferably from 80 to 200° C., yet further more preferably from 90 to 180° C., and most preferably from 100 to 170° C. Heat-expandable microspheres having an expansion-initiation temperature lower than 60° C. may have poor stability over time to thereby expand nonuniformly in molded resin articles. On the other hand, heat-expandable microspheres having an expansion-initiation temperature higher than 250° C. may be excessively heat-resistant so as to expand insufficiently.

The maximum expansion temperature (Tₘₐₓ) of the heat-expandable microspheres is not specifically restricted, and preferably ranges from 80 to 350° C., more preferably from 90 to 280° C., further more preferably from 100 to 250° C., yet further more preferably from 110 to 230° C., and most preferably from 120 to 210° C. Heat-expandable microspheres having a maximum expansion temperature lower than 80° C. may not be used for resin molding. On the other hand, heat-expandable microspheres having a maximum expansion temperature higher than 350° C. may be excessively heat-resistant so as to expand insufficiently.

The blowing agent constituting the heat-expandable microspheres is not specifically restricted if it is thermally vaporizable. The blowing agent includes, for example, C3-C13 hydrocarbons, such as propane, (iso)butane, (iso)pentane, (iso)hexane, (iso)heptane, (iso)octane, (iso)nonane, (iso)decane, (iso)undecane, (iso)dodecane, and (iso)tridecane; C14-C20 hydrocarbons, such as (iso)hexadecane and (iso)eicosane; hydrocarbons produced by fractional distillation of petroleum, such as pseudocumene, petroleum ethers, and normal paraffins or isoparaffins having an initial boiling point from 150° C. to 260° C. and/or a distillation range from 70° C. to 360° C.: their halides; fluorine-containing compounds such as hydrofluoroether; tetraalkyl silane; and compounds which decompose by heating and generate gases. One of or a combination of at least two of these blowing agents may be employed. The blowing agent may be any of linear, branched or alicyclic compounds, and is preferably an aliphatic compound.

The thermally vaporizable blowing agent encapsulated in heat-expandable microspheres preferably has a boiling point not higher than the softening point of the thermoplastic resin shell of the microspheres in order to generate a vapor pressure sufficient to expand the heat-expandable microspheres at their expansion temperature so as to attain a high expansion ratio of the microspheres. In addition, another blowing agent having a boiling point higher than the softening point of the thermoplastic resin shell can be encapsulated along with the blowing agent having a boiling point not higher than the softening point of the thermoplastic resin shell.

The ratio of the blowing agent having a boiling point higher than the softening point of the thermoplastic resin shell to the whole of the blowing agent encapsulated in the microspheres is not specifically restricted, but is preferably be not greater than 95 wt %, more preferably not greater than 80 wt %, further preferably not greater than 70 wt %, further more preferably not greater than 65 wt %, still further more preferably not greater than 50 wt %, and most preferably smaller than 30 wt %. The ratio of the blowing agent having a boiling point higher than the softening point of the thermoplastic resin shell may be greater than 95 wt % of the whole of the blowing agent encapsulated in the microspheres, though such a ratio may increase the maximum expansion temperature and decrease the expansion ratio of the microspheres.

The amount of the blowing agent encapsulated in the heat-expandable microspheres is defined by the weight percent of the blowing agent to the microspheres. The amount of the blowing agent encapsulated in the heat-expandable microspheres is not specifically restricted, and is selected according to the application of the microspheres. The amount preferably ranges from 1 to 40 wt %, more preferably from 2 to 30 wt %, and most preferably from 3 to 25 wt %. Less than 1 wt % of the blowing agent encapsulated in the microspheres may not be effective. On the other hand, more than 40 wt % of the blowing agent encapsulated in the microspheres may make the shell of microspheres thinner than a desirable shell to thereby cause gas to escape, poor heat resistance, and insufficient expansion performance of the microspheres.

The thermoplastic resin preferably is composed of a copolymer produced by polymerizing a polymerizable component containing a monomer component.

The polymerizable component is polymerized into a thermoplastic resin constituting the shell of the heat-expandable microspheres. The polymerizable component contains the monomer component as an essential component, and may contain a cross-linking agent.

The monomer component contains a monomer generally called a radically-polymerizable monomer which has a polymerizable double bond and is polymerizable through an addition reaction.

The monomer component is not specifically restricted, and includes, for example, nitrile monomers such as acrylonitrile, methacrylonitrile, and fumaronitrile; carboxyl-group-containing monomers such as acrylic acid, methacrylic acid, ethacrylic acid, crotonic acid, cinnamic acid, maleic acid, itaconic acid, fumaric acid, citraconic acid, and chloromaleic acid: vinyl halide monomers, such as vinyl chloride; vinylidene halide monomers, such as vinylidene chloride: vinyl ester monomers, such as vinyl acetate, vinyl propionate and vinyl butyrate; (meth)acrylate monomers, such as methyl (meth)acrylate, ethyl (meth)acrylate, n-butyl (meth)acrylate, t-butyl (meth)acrylate, 2-ethylhexyl (meth)acrylate, stearyl (meth)acrylate, phenyl (meth)acrylate, isobornyl (meth)acrylate, cyclohexyl (meth)acrylate, benzyl (meth)acrylate, and 2-hydroxyethyl (meth)acrylate; (meth)acrylamide monomers, such as acrylamide, substituted acrylamide, methacrylamide and substituted methacrylamide; maleimide monomers, such as N-phenyl maleimide and N-cyclohexyl maleimide; styrene monomers, such as styrene and α-methyl styrene; ethylenically unsaturated monoolefln monomers, such as ethylene, propylene, and isobutylene; vinyl ether monomers, such as vinyl methyl ether, vinyl ethyl ether and vinyl isobutyl ether; vinyl ketone monomers, such as vinyl methyl ketone; N-vinyl monomers, such as N-vinyl carbazole and N-vinyl pyrolidone; and vinyl naphthalene salts. The monomer component may contain one of or a combination of at least two of those radically-polymerizable monomers. The term, “(meth)acryl”, means acryl or methacryl.

The polymerizable component preferably contains at least one monomer component selected from the group consisting of nitrile monomers, carboxyl-group-containing monomers, (meth)acrylate monomers, styrene monomers, vinyl ester monomers, acrylamide monomers, and vinylidene halide monomers.

The polymerizable component preferably contains a nitrile monomer as the essential monomer component to thereby produce heat-expandable microspheres having a high solvent resistance. Preferable nitrile monomers are acrylonitrile and methacrylonitrile for their availability and high heat and solvent resistance of the resultant heat-expandable microspheres.

The weight ratio of acrylonitrile (AN) to methacrylonitrile (MAN) in the nitrile monomer is not specifically restricted, and preferably ranges from 10:90 to 90:10, more preferably from 20:80 to 80:20, and further more preferably from 30:70 to 80:20. The AN to MAN weight ratio less than 10:90 may impart poor gas barrier properties to the microspheres. On the other hand, the AN to MAN weight ratio greater than 90:10 may result in an insufficient expansion ratio of the microspheres.

The ratio of the nitrile monomers is not specifically restricted, and preferably ranges from 20 to 100 wt % of the monomer component, more preferably from 30 to 100 wt %, further more preferably from 40 to 100 wt %, yet further more preferably from 50 to 100 wt %, and most preferably from 60 to 100 wt %. A monomer component containing less than 20 wt % of nitrile monomer may impart poor solvent resistance of resultant microspheres.

The polymerizable component should preferably contain a carboxyl-group-containing monomer as the essential monomer component to produce heat-expandable microspheres of high heat and solvent resistance. Acrylic acid and methacrylic acid are preferable carboxyl-group-containing monomers owing to their availability and improved heat resistance of resultant heat-expandable microspheres.

The ratio of the carboxyl-group-containing monomers is not specifically restricted, and preferably ranges from 10 to 70 wt % of the monomer component, more preferably from 15 to 60 wt %, further more preferably from 20 to 50 wt %, yet further more preferably from 25 to 45 wt %, and most preferably from 30 to 40 wt %. The weight ratio of the carboxyl-group-containing monomers less than 10 wt % may cause insufficient heat resistance of resultant heat-expandable microspheres. On the other hand, the weight ratio of the carboxyl-group-containing monomers greater than 70 wt % may result in poor gas barrier properties of resultant microspheres.

For the monomer component containing a nitrile monomer and carboxyl-group-containing monomer as the essential components, the total ratio of the nitrile monomer and carboxyl-group-containing monomer should preferably be at least 50 wt % of the monomer component, more preferably at least 60 wt %, further more preferably at least 70 wt %, yet further more preferably at least 80 wt %, and most preferably at least 90 wt %.

In this case, the ratio of the carboxyl-group-containing monomer preferably ranges from 10 to 70 wt % of the total weight of the nitrile monomer and carboxyl-group-containing monomer, more preferably from 15 to 60 wt %, further more preferably from 20 to 50 wt %, yet further more preferably from 25 to 45 wt %, and most preferably from 30 to 40 wt %. A ratio of the carboxyl-group-containing monomer of less than 10 wt % may cause insufficiently improved heat and solvent resistance of the resultant heat-expandable microspheres and lead to unstable expansion performance of the resultant heat-expandable microspheres, in a high and wide temperature range over a long period of heating. On the other hand, a ratio of the carboxyl-group-containing monomer greater than 70 wt % may cause poor expansion performance of the resultant heat-expandable microspheres.

A polymerizable component containing vinylidene chloride monomers as the monomer component will improve the gas barrier properties of the resultant microspheres. The polymerizable component containing (meth)acrylate ester monomers and/or styrene monomers contributes to readily controllable thermal expansion performance of the resultant heat-expandable microspheres. The polymerizable component containing (meth)acrylamide monomers will lead to improved heat resistance of the resultant heat-expandable microspheres.

The ratio of at least one monomer selected from the group consisting of vinylidene chloride, (meth)acrylate monomers, (meth)acrylamide monomers, and styrene monomers is preferably less than 50 wt % of the monomer component, more preferably less than 30 wt %, and most preferably less than 10 wt %, A ratio thereof of greater than 50 wt % may cause poor heat resistance of the resultant microspheres,

The heat-expandable microspheres produced from the polymerizable component containing a carboxyl-group-containing monomer may be treated on their surface with a compound reactive to the carboxyl group. The compound reactive to the carboxyl group is not specifically restricted, and includes, for example, metal-containing organic compounds, epoxy resins, and silane-coupling agents.

The polymerizable component may contain a polymerizable monomer having at least two polymerizable double bonds, i.e., a cross-linking agent, in addition to the monomer component mentioned above. The polymerizable component containing a cross-linking agent prevents a decrease of the ratio of the blowing agent retained in thermally expanded microspheres (retention ratio of a blowing agent encapsulated in microspheres) so as to achieve efficient thermal expansion of the microspheres.

The cross-linking agent is not specifically restricted, and includes, for example, aromatic divinyl compounds, such as divinylbenzene; and di(meth)acrylate compounds, such as allyl methacrylate, triacrylformal, triallyl isocyanate, ethylene glycol di(meth)acrylate, diethylene glycol di(meth)acrylate, Methylene glycol di(meth)acrylate, 1,4-butanediol di(meth)acrylate, 1,6-hexanediol di(meth)acrylate,1,9-nonanediol di(meth)acryiate, 1,10-decanediol di(meth)acrylate, PEG (200) di(meth)acrylate, PEG (400) di(meth)acrylate, PEG (600) di(meth)acrylate, PPG (400) di(meth)acrylate, PPG (700) di(meth)acryiate, trimethylolpropane trimethacrylate, EO-modified trimethylolpropane trimethacrylate, glycerine dimethacrylate, dimethyloltricyclodecane diacrylate, pentaerythritol tri(meth)acrylate, pentaerythritol tetraacrylate, dipentaerythritol hexaacrylate, 2-butyl-2-ethyl-1,3-propanediol diacrylate, tris(2-acryloyloxyethyl) isocyanurate, triallyl isocyanurate, triallyl cyanurate, triglycidyl isocyanurate, polytetramethyleneglycol dimethacrylate, EO-modified bisphenol A dimethacrylate, neopentylglycol dimethacrylate, nonanediol diacrylate, trimethylol propane tri(meth)acryiate, and 3-methyl-1,5 pentanediol diacrylate. One of or a combination of at least two of those cross-linking agents may be used.

The amount of the cross-linking agent is not specifically restricted or may be zero, and preferably ranges from 0.01 to 5 parts by weight to 100 parts by weight of the monomer component, and more preferably from 0.1 to 1 part by weight in order to properly control the degree of cross-linking, retention ratio of the blowing agent encapsulated in heat-expandable microspheres, and the heat resistance and thermal expansion performance of the microspheres.

The heat-expandable microspheres are usually produced in a method including polymerization of the above-mentioned polymerizable component in an aqueous dispersion medium in which an oily mixture containing the polymerizable component and blowing agent is dispersed. The polymerizable component is preferably polymerized in the presence of a polymerization initiator.

### Organic Base Component

The organic base component is an organic compound kneaded along with the heat-expandable microspheres to be prepared into the masterbatch of the present invention. The organic base component improves the handling properties of the masterbatch and also the dispersibility of the heat-expandable microspheres in the molding composition in which the masterbatch is contained. The organic base component also improves the dispersibility of the thermally expanded microspheres in the foamed molded articles manufactured from the molding composition so as to exert the effect of making the foamed molded articles more lightweight.

The melt flow rate (MFR, g/10 min) of the organic base component should usually be higher than 50 and not higher than 2200, more preferably ranging from 60 to 2000,

further more preferably ranging from 75 to 1800, still more preferably ranging from 100 to 1600, yet more preferably ranging from 125 to 1400, still further more preferably ranging from 150 to 1200, yet further more preferably ranging from 400 to 1100, yet further more preferably ranging from 500 to 1100, and most preferably ranging from 650 to 1050. The melt flow rate mentioned here is determined with a capillary rheometer according to the method of JIS K7210-1:1999 with 2.16-kg loading at 190° C.

The organic base component having a melt flow rate of 50 g/10 min or lower may result in unstable expansion ratio of the molding composition containing the masterbatch and lead to a variation in specific gravity, failure in light-weight effect and poor appearance of the foamed molded articles produced from the molding composition. On the other hand, the organic base component having a melt flow rate higher than 2200 g/10 min may result in a sticky masterbatch with poor handling properties in the masterbatch preparation process leading to inconstant masterbatch preparation.

The melting point of the organic base component is not specifically restricted except that it should be lower than the expansion-initiation temperature of the heat-expandable microspheres. The melting point preferably ranges from 45 to 180° C., more preferably from 50 to 160° C., further more preferably from 55 to 140° C., yet further more preferably from 60 to 120° C. and most preferably from 65 to lower than 100° C. An organic base component having a melting point lower than 45° C. may cause poor handling properties of the masterbatch, for example, fusion of the masterbatch at the feed inlet of a molding machine for preparing the molding composition, which leads to inconstant feeding of the masterbatch to the molding machine. On the other hand, an organic base component having a melting point higher than 180° C. requires the molding composition containing the masterbatch to be kneaded at 180° C. or higher in the manufacture of foamed molded articles. Further, the high kneading temperature gives excessive heat history to the heat-expandable microspheres and decreases the expansion ratio of the microspheres so as to hinder the manufacture of lightweight articles.

The material for the organic base component is not specifically restricted, and is preferably an ethylenic polymer, Ethylenic polymers are polymers produced from a monomer mixture essentially containing ethylene monomer, and may be produced from a monomer mixture containing ethylene and other monomers polymerizable with ethylene.

The monomers polymerizable with ethylene are not specifically restricted, and include, for example, carboxyl-group-containing monomers such as acrylic acid, methacrylic acid, ethacrylic acid, crotonic acid, cinnamic acid, maleic acid, itaconic acid, fumaric acid, citraconic acid, and chloromaleic acid; vinyl halide monomers, such as vinyl chloride; vinylidene halide monomers, such as vinylidene chloride; vinyl ester monomers, such as vinyl acetate, vinyl propionate and vinyl butyrate; (meth)acrylate monomers, such as methyl (meth)acrylate, ethyl (meth)acrylate, n-butyl (meth)acrylate, t-butyl (meth)acrylate, 2-ethylhexyl (meth)acrylate, stearyl (meth)acrylate, phenyl (meth)acrylate, isobomyl (meth)acrylate, cyclohexyl (meth)acrylate, benzyl (meth)acrylate, and 2-hydroxyethyl (meth)acrylate; and maleic acid anhydride. One or a combination of at least two of these monomers may be used.

Of those monomers, at least one monomer selected from the group consisting of vinyl acetate, acrylic acid, methacrylic acid, methyl (meth)acrylate, ethyl (meth)acrylate and maleic acid anhydride is preferable for controlling the melt flow rate of the resultant organic base component (ethylenic polymer) within a specific range.

The ratio of ethylene monomer to all monomers constituting the ethylenic polymer (i.e., the ratio of ethylene monomer to the amount of all monomers from which repeating units of the ethylenic polymer are derived) (hereinafter also referred to as ethylene content) is not specifically restricted, and preferably ranges from 50 to 100 wt %, more preferably from 60 to 100 wt %, further more preferably from 60 to 98 wt %, and most preferably from 70 to 90 wt %. An ethylenic polymer having an ethylene content of less than 50 wt % may sometimes cause poor heat resistance and poor thermal stability of the resultant foamed molded articles.

The true specific gravity of the organic base component is not specifically restricted, and preferably ranges from 0.88 to 0.98, more preferably from 0.90 to 0.97, and further more preferably from 0.92 to 0.96. A true specific gravity of the organic base component beyond the range from 0.88 to 0.98 is excessively different from the specific gravity of the matrix component mentioned below. In that case, the molding composition composed of the matrix component and the masterbatch containing the organic base component may be manufactured into foamed molded articles which are not lightweight and have a nonuniform specific gravity.

The tensile fracture stress of the organic base component is not specifically restricted, and is preferably 30 MPa or lower, more preferably 20 MPa or lower, further more preferably 10 MPa or lower, yet further more preferably 5 MPa or lower, and most preferably 3 MPa or lower. The preferable lowest limit of the tensile fracture stress of the organic base component is 0.1 MPa. An organic base component having a tensile fracture stress lower than 0.1 MPa may result in foamed molded articles having insufficient strength that are manufactured from the molding composition containing the masterbatch in which the organic base component is blended. On the other hand, the organic base component having a tensile fracture stress higher than 30 MPa may result in a variation in expansion ratio and nonuniform specific gravity of the foamed molded articles containing the masterbatch. Thus the foamed molded articles may not be lightweight and may have poor appearance. The tensile fracture stress mentioned herein is determined according to JIS K6924-2:1997.

### Masterbatch and its Preparation Process

The masterbatch of the present invention contains the heat-expandable microspheres and organic base component mentioned above.

The ratio of the heat-expandable microspheres in the masterbatch is not specifically restricted, and preferably ranges from 30 to 80 wt % of the total weight of the heat-expandable microspheres and organic base component, more preferably from 35 to 75 wt %, further more preferably from 40 to 70 wt %, yet furthermore preferably from 50 to 70 wt %, and most preferably from 60 to 70 wt %. A ratio of the heat-expandable microspheres of less than 30 wt % may result in a sticky masterbatch with poor handling properties in the masterbatch preparation process so as to cause unstable operation. On the other hand, a ratio of the heat-expandable microspheres that is higher than 80 wt % may result in a variation in expansion ratio and nonuniform specific gravity of the foamed molded articles containing the masterbatch, and the foamed molded articles may not be lightweight and may have a poor appearance.

The cross section of the masterbatch pellets vertically to their length is optionally selected according to their use, and includes, for example, a circle, oval, polygons, star, and hollow circle.

The length of the masterbatch pellets is also selected optionally according to their use, and should preferably range from 1 to 10 mm, more preferably from 1.5 to 7.5 mm, and most preferably from 2 to 5 mm. Masterbatch pellets having a length beyond the range of from 1 to 10 mm may cause poor dispersibility of the heat-expandable microspheres so as to result in a variation in expansion ratio and nonuniform specific gravity of the foamed molded articles manufactured from the molding composition containing the masterbatch pellets. Thus the resultant foamed molded articles may not be lightweight and may have a poor appearance.

The long axis of the cross section of the masterbatch pellets is also selected optionally according to their use, and preferably ranges from 0.03 to 5 mm, more preferably from 0.05 to 4 mm, and most preferably from 0.1 to 3 mm. The masterbatch pellets having a long axis of the cross section beyond the range from 0.03 to 5 mm may cause poor dispersibility of the heat-expandable microspheres contained in the masterbatch pellets so as to result in a variation in expansion ratio and nonuniform specific gravity of the foamed molded articles manufactured from the molding composition containing the masterbatch pellets. Thus the resultant molded articles may not be lightweight and may have a poor appearance.

The specific gravity of the masterbatch is not specifically restricted, and preferably ranges from 0.60 to 1.5, more preferably from 0.65 to 1.3, and most preferably from 0.7 to 1.2. A masterbatch having a specific gravity beyond the range of from 0.60 to 1.5 may contain heat-expandable microspheres which have partially expanded or which have been broken, and the foamed molded articles manufactured from the molding composition containing the masterbatch may have a low expansion ratio and may not be lightweight.

The expansion ratio of the masterbatch is not specifically restricted, and preferably ranges from 5 to 120 times, more preferably from 10 to 100 times, and most preferably from 15 to 75 times. The masterbatch having an expansion ratio of less than 5 times may result in foamed molded articles which have a low expansion ratio and are not lightweight. On the other hand, a masterbatch having an expansion ratio higher than 120 times may result in foamed molded articles filled with the heat-expandable microspheres expanding not only inside the articles, but also at their surface so as to cause poor appearance of the articles.

The masterbatch may be prepared by any method of mixing the heat-expandable microspheres and organic base component, and a method of uniformly dispersing those components is preferable. The method for preparing the masterbatch includes, for example, a method including a pre-kneading step (1) and a pelletization step (2) mentioned below.

(1) Pre-kneading step: The organic base component is melted and kneaded in a kneader such as a roller kneader, regular kneader, pressure kneader or Banbury mixer, and the heat-expandable microspheres are then added and kneaded to prepare the pre-kneaded mixture.

(2) Pelletization step: The pre-kneaded mixture is fed to a single screw-extruder, twin screw extruder or multi-screw extruder which extrudes the molten mixture into a desirable diameter, and the extruded mixture is pelletized with a hot-cut pelletizer.

A long masterbatch can be manufactured by extruding the masterbatch strand into a desirable diameter from an extruder, and cutting the strand into a desirable length. The diameter of the extruded strand can be changed by adjusting the diameter of the strand die of the extruder and the strand take-up speed.

The masterbatch of the present invention should be prepared at a temperature below the expansion-initiation temperature of the heat-expandable microspheres to prevent the expansion of the microspheres. The masterbatch is preferably prepared at a temperature that is at least 5° C. lower than the expansion-initiation temperature of the heat-expandable microspheres. The temperature for preparing the masterbatch is quite different from the temperature for molding the foamed molded articles. This is because the molding composition containing the masterbatch is usually molded at about the maximum, expansion temperature of the heat-expandable microspheres to be manufactured into the foamed molded articles specifically described below. For these reasons, the matrix component constituting the molding composition and foamed molded articles is often different from the organic base component contained in the masterbatch. Usually, the organic base component contained in

the masterbatch has a lower softening temperature than the matrix component constituting the molding composition and foamed molded articles. If the molding composition contains a considerable amount of the masterbatch in order to make the foamed molded articles lighter, the heat resistance and strength of the resultant foamed molded articles may be impaired. The matrix component constituting the molding composition and the foamed molded articles may be the same as the organic base component in the masterbatch.

The masterbatch of the present invention may further contain molding additives, such as stabilizers, lubricants, fillers, and dispersion improvers in addition to the organic base component and heat-expandable microspheres. The masterbatch preferably contains no lubricants. This is because lubricants may impair the strength of the resultant foamed molded articles.

The stabilizers include, for example, phenolic stabilizers, such as pentaerythrityl-tetrakis-[3-(3,5-di-t-butyl-4-hydroxyphenyl) propionate] and tri ethylene glycol-bis-[3-(3-t-butyl-5-methyl-4-hydroxyphenyl) propionate]; phosphoric stabilizes, such as iris (monononylphenyl) phosphite and tris (2,4-di-t-butylphenyl) phosphite; and sulfuric stabilizers, such as dilauroyl dipropionate. One of or a combination of at least two of the stabilizers may be used.

The ratio of the stabilizers preferably ranges from 0.01 to 1.0 part by weight to 100 parts by weight of the organic base component, and more preferably from 0.05 to 0.5 parts by weight. A ratio of the stabilizers of lower than 0.01 parts by weight may be insufficient to exert their effect. On the other hand, a ratio of the stabilizers higher than 1.0 part by weight may adversely affect their function.

The lubricants include, for example, sodium, calcium or magnesium, salts of saturated or unsaturated fatty acids, such as lauric acid, palmitic acid, oleic acid and stearic acid. One of or a combination of at least two of those lubricants may be used.

The ratio of the lubricants preferably ranges from 0.1 to 2.0 parts by weight to 100 parts by weight of the organic base component. The ratio of the lubricants lower than 0.1 parts by weight may be insufficient to exert their effect. On the other hand, a ratio of the lubricants higher than 2.0 parts by weight may adversely affect their function.

The fillers include those of various forms, such as fibrous form, granule, powder, plate, and needle. The fillers include, for example, vegetable fibers, such as wood powder and kenaf fiber; polyethylene fiber, polypropylene fiber, nylon fiber, polyester fiber, glass fiber (including metal-coated glass fiber), carbon fiber (including metal-coated carbon fiber), potassium titanate, asbestos, silicon carbide, silicon nitride, ceramic fiber, metal fiber, aramid fiber, barium sulfate, calcium sulfate, calcium silicate, calcium carbonate, magnesium carbonate, antimony trioxide, zinc oxide, titanium oxide, magnesium oxide, iron oxide, molybdenum disulfide, magnesium hydroxide, aluminum hydroxide, mica, talc, kaolin, pyrophyllite, bentonite, sericite, zeolite, wollastonite, alumina, clay, ferrite, graphite, gypsum, glass beads, glass balloons and quartz. One of or a combination of at least two of these fillers may be used. Of these fillers, talc, calcium carbonate and magnesium hydroxide are preferable.

The ratio of the fillers preferably ranges from 0.1 to 50 parts by weight to 100 parts by weight of the organic base component, and more preferably from 1 to 50 parts by weight. A ratio of the fillers lower than 0.1 parts by weight may be insufficient to exert their effect. On the other hand, a ratio of the fillers that is higher than 50 parts by weight may adversely affect their function.

The dispersion improvers include, for example, aliphatic hydrocarbons, paraffinic process oils, such as paraffin oil, aromatic process oils, such as aromatic oil, liquid paraffin, petrolatum, gilsonite, and petroleum asphalt.

The ratio of the dispersion improvers is not specifically restricted, and is preferably not higher than 25 wt % to the total weight of the heat-expandable microspheres and organic base component, more preferably not higher than 20 wt %, and most preferably not higher than 15 wt %, A ratio of the dispersion improvers higher than 25 wt % may cause bleedout of the dispersion improvers from the resultant foamed molded articles.

Molding composition, foamed molded articles and process for manufacturing the articles

The foamed molded articles are manufactured by molding the molding composition containing the masterbatch and matrix component.

The matrix component is not specifically restricted, and includes, for example, polyvinyl chloride; polyvinylidene chloride; polyvinyl alcohol; ethylenic copolymers, such as ethylene-vinyl alcohol copolymer, ethylene-vinyl acetate copolymer, ethylene-methyl (meth)acrylate copolymer, ethylene-ethyl (meth)acrylate copolymer and ethylene-butyl (meth)acrylate copolymer; ionomers; polyolefin resins, such as low density polyethylene, high density polyethylene, polypropylene, polybutene, polyisobutylene, polystyrene and polyterpene; styrenic copolymers, such as styrene-acrylomtrile copolymer and styrene-butadiene-acrylonitrile copolymer; polyacetal; polymethyl methacrylate; cellulose acetate; polycarbonate; polyester resins, such as polyethylene terephthalate and polyhutylene terephthalate; polyamide resins, such as nylon 6 and nylon 66; thermoplastic polyurethanes; ethylene tetrafluoride; ionomer resins, such as ethylene ionomers, urethane ionomers, styrene ionomers and fluorine ionomers; polyacetal; thermoplastic resins such as polyphenylene sulfide; thermoplastic elastomers, such as polyurethane elastomers, styrenic elastomers, olefinic elastomers, polyamide elastomers and polyester elastomers; bioplastics such as polylactic acid, cellulose acetate, PBS, PHA and starch resins; and their mixtures.

Of these matrix components, thermoplastic elastomers are preferable for manufacturing foamed molded articles used for sealing materials. That is because thermally expanded microspheres are dispersed well in the foamed molded articles to make the articles lighter and have better sealing performance. The elastomers preferable for the matrix component are polyurethane elastomers, styrene elastomers, olefin elastomers, polyamide elastomers and polyester elastomers, because these elastomers contribute to the manufacture of foamed molded articles having a high heat resistance.

The olefin elastomers include, for example, a mixture of a hard-segment polymer and soft-segment polymer, and a copolymer of a hard-segment polymer and soft-segment polymer.

The hard segments in the olefin elastomers include, for example, a polypropylene segment. The soft segments in the olefin elastomers include, for example, a polyethylene segments and a segment of a copolymer of ethylene and a small amount of dienes, such as, ethylene-propylene copolymer (EPM), ethylene-propylene-diene copolymer (EPDM), and EPDM partially crosslinked with organic peroxides.

The polymer mixtures or copolymers for the olefin elastomers may be grafted with unsaturated hydroxy monomers and their derivatives, and with unsaturated carhoxylie acid monomers and their derivatives.

Commercially available olefin elastomers include, for example, “Santoprene™” and “Vistamaxx™” supplied by Exxon Mobil Corporation, “EXCELINK” supplied by JSR Corporation, “MAXIRON” supplied by Showa Kasei Kogyo Co., Ltd, “Espolex TPE series” supplied by Sumitomo Chemical Co., Ltd., “ENGAGE™” supplied by The Dow Chemical Japan Company, “Prime TPO” supplied by Prime Polymer Co., Ltd., “Milastomer” supplied by Mitsui Chemicals, Inc., “ZELAS™” and “THERMORUN™” supplied by Mitsubishi Chemical Corporation, “MULTIUSE LEOSTOMER”, “OLEFLEX” and “TRINITY FR” supplied by Riken Technos Corp.

The styrene elastomer should preferably be a block copolymer for achieving high and stable expansion ratio of the foamed molded articles manufactured from the molding composition containing the masterbatch.

The hard segment of the block copolymer type styrene elastomer includes, for example, a polystyrene segment, and the soft segment of the styrene elastomer includes, for example, a segment of polybutadiene, hydrogenated polybutadiene, polyisoprene or hydrogenated polyisoprene. The styrene elastomers include styrenic block copolymers, for example, styrene-butadiene-styrene (SBS) copolymer, styrene-isoprene-styrene (SIS) copolymer, styrene-ethylene-butylene-styrene (SEBS) copolymer, styrene-ethylene-propylene-styrene (SEPS) copolymer and styrene-butadiene-butylene-styrene (SBBS) copolymer.

Commercially available styrene elastomers include, for example, “TUFPRENE™”, “ASAPRENE™” and “Tuftec™” supplied by Asahi Kasei Corporation, “Elastomer AR” supplied by Aronkasei Co., Ltd., “SEPTON” and “HYBRAR” supplied by Kuraray Co., Ltd., “ISR TR” and “JSR SIS” supplied by JSR Corporation, “MAXIRON” supplied by Showa Kasei Kogyo Co., Ltd, “TRI-BLENE” and “SUPER TRI-BLENE” supplied by Shinko Kasei Co., Ltd., “Espolex SB series” supplied by Sumitomo Chemical Co., Ltd., “LEOSTOMER”, “ACTYMER”, “HYPER ALLOY ACTYMER” and “ACTYMER G” supplied by Riken Technos Corp., and “RABALON™” supplied by Mitsubishi Chemical Corporation.

The polyester elastomer is preferably a block copolymer for improved expansion of thermally expanded microspheres in the foamed molded articles manufactured from the molding composition containing the masterbatch. In addition, the polyester elastomer is preferably a polyether-ester type elastomer. This is because the elastomer softens the molding composition to improve the dispersion of the thermally expanded microspheres in the foamed molded articles manufactured from the molding composition containing the masterbatch.

The block copolymer type polyester elastomer is preferably composed of the hard segment of polybutylene terephthalate and soft segment of poly(polyoxyethylene) terephthalate. The hard segment is a crystalline phase contributing to high mechanical strength, resistance to thermal deformation and good handling properties of the elastomer. The soft segment is an amorphous phase contributing to the softness, shock-absorbing performance and low-temperature characteristics of the elastomer.

The ratio of the soft segment, poly(polyoxyethylene) terephthalate, in the polyester elastomer is not specifically restricted, and preferably ranges from 5 to 95 wt %, more preferably from 10 to 90 wt % and most preferably from 15 to 85 wt %. A polyester elastomer containing 5 wt % or less of the soft segment may be hard.

Commercially available polyester elastomers include, for example, “PRXMALLOY™” supplied by Mitsubishi Chemical Corporation, “PELPRENE™” supplied by Toyobo Co., Ltd., and “Hytrel” supplied by Du Pont-Toray Co., Ltd.

The ratio of the heat-expandable microspheres contained in the molding composition is not specifically restricted, and preferably ranges from 0.01 to 60 wt % of the molding composition, more preferably from 0.1 to 50 wt %, further more preferably from 0.5 to 20 wt %, and most preferably from 1 to 10 wt %. A molding composition containing less than 0.01 wt % of the heat-expandable microspheres may not result in the manufacture of lightweight foamed molded articles. On the other hand, a molding composition containing greater than 60 wt % of the heat-expandable microspheres is manufactured into sufficiently lightweight foamed molded articles, although the articles may have extremely low mechanical strength.

The ratio of the matrix component contained in the molding composition is not specifically restricted, and preferably ranges from 40 to 99.99 wt % of the molding composition, more preferably from 50 to 99.9 wt %, further more preferably from 80 to 99.5 wt %, and most preferably from 90 to 99 wt %. A molding composition containing less than 40 wt % of the matrix component is manufactured into sufficiently lightweight foamed molded articles, although the articles may have extremely low mechanical strength. On the other hand, a molding composition containing greater than 99.99 wt % of the matrix component may not result in the manufacture of lightweight foamed molded articles.

The molding composition may contain molding additives, such as stabilizers, lubricants, fillers and dispersion improvers in addition to the matrix component and masterbatch containing the heat-expandable microspheres.

The ratio of the stabilizers preferably ranges from 0.01 to 1.0 part by weight to 100 parts by weight of the matrix component, and more preferably from 0.05 to 0.5 parts by weight. A ratio of the stabilizers lower than 0.01 parts by weight may be insufficient to exert their effect. On the other hand, a ratio of the stabilizers higher than 1.0 part by weight may impair the performance of the resultant foamed molded articles.

The ratio of the lubricants preferably ranges from 0.1 to 2.0 parts by weight to 100 parts by weight of the matrix component. A ratio of the lubricants lower than 0.1 parts by weight may be insufficient to exert their effect. On the other hand, a ratio of the lubricants higher than 2.0 parts by weight may impair the performance of the resultant foamed molded articles.

The ratio of the fillers preferably ranges from 0.1 to 50 parts by weight to 100parts by weight of the matrix component, and more preferably from 1 to 50 parts by weight. A ratio of the fillers lower than 0.1 parts by weight may be insufficient to exert their effect. On the other hand, a ratio of the fillers that is higher than 50 parts by weight may impair the performance of the resultant foamed molded articles.

The molding process for the molding composition may include various processes, such as injection molding, extrusion molding, blow molding, calendaring, compression molding and vacuum molding. Extrusion molding is preferable for the molding composition processed into sealing materials. The heat-expandable microspheres thermally expand into hollow particles, and thus the foamed molded articles contain hollow particles.

The expansion ratio of the foamed molded articles manufactured from the molding composition is not specifically restricted, and preferably is at least 1.1 times, more preferably ranging from 1.2 to 5 times, further more preferably from 1.4 to 4 times, and most preferably from 1.5 to 3 times. A foamed molded article expanded to less than 1.1 times may not result in a lightweight article. On the other hand, a foamed molded article expanded to greater than 5 times is sufficiently lightweight, although it has extremely low strength.

The hollow particles contained in the foamed molded articles are obtained by thermally expanding the heat-expandable microspheres mentioned above. The mean particle size of the hollow particles is not specifically restricted, and preferably ranges from 1 to 500 μm, more preferably from 2 to 300 μm, and most preferably from 5 to 200 μm. The hollow particles form closed cells or bubbles in the foamed molded articles, and the foamed molded articles containing the bubbles of mean bubble size less than 1 μm may not be sufficiently lightweight. On the other hand, the foamed molded articles having a mean bubble size greater than 500 μm may have low strength.

The mean bubble size attained by the hollow particles in the foamed molded articles for sealing materials preferably ranges from 1 to 60 μm, more preferably from 5 to 50 μm, further more preferably from 10 to 40 μm, and most preferably from 15 to 38 μm. When the hollow particles form bubbles of a mean bubble size beyond the range from 1 to 60 μm, the sealing materials of the foamed molded articles containing such bubbles may have poor sealing performance. For example, if the hollow particles form bubbles of a mean bubble size less than 1 μm, a considerable amount of hollow particles is required to manufacture lightweight foamed molded articles. Also, the properties of the soft materials may be adversely affected, to thereby impair the sealing performance of the resultant articles. On the other hand, if the hollow particles form bubbles having a mean bubble size greater than 60 μm, the foamed molded articles have a rough and uneven surface which may impair the sealing performance of the resultant articles.

The coefficient of variation, CV, of the particle size distribution of the hollow particles is not specifically restricted, and preferably is not greater than 35%, more preferably not greater than 30% and most preferably not greater than 25%.

The ratio of the hollow particles contained in the foamed molded articles is not specifically restricted, and preferably ranges from 0.01 to 60 wt % of the foamed molded articles, more preferably from 0.1 to 50 wt %, further more preferably from 0.5 to 20 wt % and most preferably from 1 to 10 wt %. The foamed molded articles containing less than 0.01 wt % of the hollow particles may not be lightweight. On the other hand, foamed molded articles containing greater than 60 wt % of the hollow particles are lightweight enough, but may have extremely low mechanical strength.

The ratio of the matrix component contained in the foamed molded articles is not specifically restricted, and preferably ranges from 40 to 99.99 wt % of the foamed molded articles, more preferably from 50 to 99.9 wt %, further more preferably from 80 to 99.5 wt % and most preferably from 90 to 99 wt %. Foamed molded articles containing less than 40 wt % of the matrix component are lightweight enough, but may have extremely low mechanical strength. On the other hand, foamed molded articles containing greater than 99.99 wt % of the matrix component may not be lightweight.

The masterbatch of the present invention easily and sufficiently disperses the heat-expandable microspheres in the matrix component, even if the matrix component is a soft material, such as a thermoplastic elastomer. Further, only a weak shear strength is applied to the matrix component and the masterbatch in the extrusion cylinder of a molding machine. Thus, the resultant foamed molded articles have uniform specific gravity and are lightweight as the result of uniform and entire expansion. In addition, the foamed molded articles have a good appearance and excellent sealing performance so as to be advantageously used as sealing materials. Specifically, the articles are advantageous sealing materials for automotive weathers trippings including glass ran channels and body sealers, and for builder weatherstrippings including window weatherstrippings and door weatherstrippings. An example of the automotive weathers tripping manufactured of the masterbatch of the present invention is shown in the figure. The diagram in the figure is the cross section of an automotive weatherstripping (a foamed molded article) manufactured by molding the molding composition containing the masterbatch of the present invention and a matrix component with an extrusion molding machine.

### EXAMPLE

Although examples of the present invention are described in detail below, the present invention should not be construed as being limited thereto. The percent (%) and part(s) mentioned in the following examples and comparative examples respectively are given in mean weight percent (wt %) and part(s) by weight unless otherwise specified.

Prior to the description of the Examples, examples of the production of several heat-expandable microspheres are described. The heat-expandable microspheres may hereinafter be referred to as “microspheres” for concise description.

### Mean Particle Size and Particle Size Distribution

Microspheres were analyzed in the dry system of a laser diffraction particle size analyzer (HEROS & RGDQS, manufactured by SYMPATEC) with a dispersion pressure of 5.0 bar and the vacuum of 5.0 mbar in a dry dispersion unit, and the mean volume diameter D50 determined in the analysis was defined as the mean particle size.

### Determination of Expansion-Initiation Temperature (Ts) and Maximum Expansion Temperature (Tₘₐₓ) of Heat-Expandable Microspheres

Ts and Tₘₐₓ were determined with a DMA (DMA Q800, manufactured by TA Instruments). In an aluminum cup of 4.8 mm deep and 6.0 mm in diameter (5.65 mm in inside diameter), 0.5 mg of heat-expandable microspheres were placed, and the cup was covered with an aluminum cap 0.1 mm thick and 5.6 mm in diameter to prepare a sample. The sample was set on the device and subjected to the pressure of 0.01 N with the compression unit of the device, and the height of the sample was measured. The sample was then heated at temperatures elevating at a rate of 10° C./min in the temperature range from 20to 350° C., being subjected to the pressure of 0.01 N with the compression unit, and the vertical change of the position of the compression unit was measured. The temperature at which the compression unit started to change its position to the positive direction was determined as the expansion-initiation temperature (Ts), and the temperature at which the compression unit indicated the highest position was determined as the maximum expansion temperature (Tₘₐₓ).

The specific gravity of a masterbatch was determined by a liquid substitution method (Archimedean method) with isopropyl alcohol in an atmosphere at 25° C. and 50% RH (relative humidity) as described below.

More specifically, an empty 100-mL measuring flask was dried and weighed (WB₁), Then isopropyl alcohol was poured into the weighed measuring flask to accurately form meniscus, and the measuring flask filled with isopropyl alcohol was weighed (WB₂). Then another 100-mL measuring flask was dried and weighed (WS₁). The weighed measuring flask was then filled with about 50 mL of the masterbatch, and the measuring flask filled with the masterbatch was weighed (WS₂). Then isopropyl alcohol was poured into the measuring flask filled with the masterbatch to accurately form a meniscus without taking bubbles into the isopropyl alcohol, and the flask filled with the masterbatch and isopropyl alcohol was weighed (WS₃). The values, WB₁, WB₂, WS₁, WS₂, and WS3, were introduced in the following mathematical expression to calculate the specific gravity (d) of the masterbatch.

d=[(WS₂−WS₁)×(WB₂−WB₁)/100]/[(WB₂−WB₁)−(WS₃−WS₂)]

### Specific Gravity and Expansion Ratio of the Foamed Molded Articles

The specific gravity of a foamed molded article (D1) was measured by a liquid substitution method with a precision densimeter AX200 (manufactured by Shimadzu Corporation). The expansion ratio of the foamed molded article was calculated from D1 and the true specific gravity of the matrix component (D2) contained in the foamed molded article by the following mathematical expression.

Expansion ratio (times)=D₂/D₁

### Example of Production 1

An aqueous dispersion medium, was prepared by adding 150 g of sodium chloride, 50 g of colloidal silica dispersion (containing 20 wt % of silica having the mean particle size of 10 nm), 1 g of polyvinyl pyrolidone, and 0.5 g of ethylenediaminetetraaceticacid tetrasodiumsalt to 600 g of deionized water and controlling the pH of the mixture at about 3.

An oily mixture was prepared by mixing 80 g of acrylonitrile, 120 g of methacrylonitrile, 100 g of methacrylic acid, 1 g of trimethylolpropane trimethacrylate, 40 g of isopentane, 40 g of isooctane, and 8 g of 70-% di-(2-ethylhexyl) peroxydicarbonate solution.

The aqueous dispersion medium and the oily mixture were mixed and agitated with a Homo-mixer to be prepared into a suspension. Then the suspension was transferred to a 1.5-liter compression reactor, purged with nitrogen, and polymerized with agitation at 80rpm under the initial reaction pressure at 0.5 MPa at 50° C. for 20 hours. The resultant polymerization product was filtered and dried to obtain heat-expandable microspheres. Hie properties of the microspheres are shown in Table 1.

### Examples of Production 2 to 4

Heat-expandable microspheres were produced in the same manner as that in Example of production 1, except that the components and their amount were replaced by those shown in Table 1. The properties of the resultant microspheres are shown in Table 1.

The heat-expandable microspheres produced in the examples of production 1to 4 mentioned above are respectively referred to as microspheres (1) to (4).

TABLE 1

| | | | Ex. 1 | Ex. 2 | Ex. 3 | Ex. 4 |
|---|---|---|---|---|---|---|
| | | | Micro- | Micro- | Micro- | Micro- |
| | | | spheres (1) | spheres (2) | spheres (3) | spheres (4) |
| Aqueous | | Deionized water | 600 | 600 | 600 | 600 |
| dispersion | | Sodium chloride | 150 | 150 | 150 | 150 |
| medium (g) | | Colloidal silica | 50 | 60 | 40 | 30 |
| | | PVP | 1 | 1 | 1 | 1 |
| | | EDTA | 0.5 | 0.5 | 0.5 | 0.5 |
| | | pH | 3 | 3 | 3 | 3 |
| Oily mixture (g) | Monomer component | AN | 80 | 165 | 155 | 100 |
| | | MAN | 120 | 120 | 130 | 80 |
| | | MAA | 100 | — | — | 120 |
| | | MMA | | 15 | 5 | |
| | Cross-linking agent | TMP | 1 | — | 0.5 | 1 |
| | | EDMA | — | 1 | 0.5 | — |
| | Polymerization initiator | OPP | 8 | 6 | 6 | 8 |
| | Blowing agent | Isobutane | — | — | 60 | — |
| | | Isopentane | 40 | 60 | 40 | 80 |
| | | Isooctane | 40 | 30 | — | — |

| | | | | | |
|---|---|---|---|---|---|
| Properties of | Mean particle size (D50) μm | 10 | 20 | 40 | 35 |
| microspheres | Expansion-initiation temp. (° C.) | 160 | 135 | 105 | 150 |
| | Maximum expansion temp. (° C.) | 220 | 175 | 165 | 210 |

### EXAMPLE 1

### Masterbatch

In a 10-L compression kneader, 2.4 kg of ethylene-ethyl acrylate copolymer (NUC-6070, having a melt flow rate of 250 g/10 min, melting point of 87° C., ethylene content of 75 wt %, true specific gravity of 0.94, tensile fracture stress of 5 MPa, supplied by The Dow Chemical Japan Company) for the organic base component was melted and kneaded, and 5.6 kg of the heat-expandable microspheres produced in Example of production 1 was added to the molten copolymer at the kneading temperature of 95 ° C. to be uniformly mixed to prepare the premix. The extrusion rate of the premix from the compression kneader was measured to predict the extrusion performance (handling properties) of the masterbatch in the preparation process according to the criteria described below, and the premix exhibited good extrusion performance. The result is shown in Table 2.

Then the resultant premix was fed to a twin screw extruder with the cylinder diameter of 40 mm, and extruded at 90° C. to be processed into a masterbatch containing 70wt % of the heat-expandable microspheres and having the specific gravity of 0.95.

### Foamed Molded Article

A Labo Plastomill (ME-25, a twin screw extruder manufactured by Toyo Seiki Seisaku-Sho Ltd.) and a T die (with the lip width of 150 mm and thickness of 1 mm) were used. The molding temperature of the extruder and T die was set at 210° C. and the screw speed was set at 40 rpm. An olefin elastomer (EXCELINK 3300B, with the true specific gravity of 0.88 and the Shore A hardness of 29, supplied by JSR Corporation) was used for the matrix component of a foamed molded article. The masterbatch mentioned above was dry blended with the olefin elastomer to prepare a molding composition containing 3 parts by weight of the heat-expandable microspheres to 100 parts by weight of the olefin elastomer.

The resultant molding composition was fed to the feed hopper of the Labo Plastomill and processed into a foamed molded sheet (with the expansion ratio of 1.6 times and specific gravity of 0.55).

The appearance and mean bubble size of the resultant foamed molded sheet were evaluated and measured as described below. The resultant sheet had good surface properties without aggregation. The result is shown in Table 2.

### Extrusion Performance (Handling Properties)

Good: The extrusion yield of the premix from the compression kneader is equal to or higher than 85% of the total of the organic base component and heat-expandable microspheres.

Poor: The extrusion yield of the premix from the compression kneader is less than 85% of the total of the organic base component and heat-expandable microspheres.

### Aggregation in the Foamed Molded Sheet

Good: No aggregation was found in visual inspection of the 1-m long foamed molded sheet.

Poor: Aggregation was found in visual inspection of the 1-m. long foamed molded sheet.

### Determination of Mean Bobble Size

The foamed molded sheet was cut and the microphotographs of the cut sheet were taken using a scanning electron microscope (VE-8800, manufactured by Keyence Corporation) with accelerating voltage of 20 kY and a magnification ratio of 30. A 3-mm square area was randomly selected, and the diameter of the bubbles seen in the area was measured and calculated into the mean bubble size.

### EXAMPLES 2 TO 7 AND COMPARATIVE EXAMPLES 1 TO 5

The masterbatches, molding compositions and foamed molded articles were

prepared in the same manner as in Example 1 except that the organic base component, heat-expandable microspheres, their ratio, processing conditions, matrix component, and molding temperature were replaced by those shown in Table 2. The properties of the resultant products are shown in Table 2.

TABLE 2

| | | | Examples | | | | | | |
|---|---|---|---|---|---|---|---|---|---|
| | | | 1 | 2 | 3 | 4 | 5 | 6 | 7 |
| Masterbatch | Heat-expandable microspheres | | (1) | (1) | (2) | (3) | (4) | (1) | (4) |
| | Organic base | Type | EEA(1) | EEA(1) | EMA(1) | EVA(1) | EVA(2) | EMAA(1) | LDPE(1) |
| | component | MFR (g/10 min) | 250 | 250 | 450 | 150 | 1000 | 100 | 145 |
| | | Melting point | 87 | 87 | 67 | 69 | 62 | 95 | 100 |
| | | Ethylene content (wt %) | 75 | 75 | 72 | 72 | 72 | 89 | 100 |
| | | Tensile fracture stress | 5 | 5 | 2 | 4 | 1 | 16 | 8 |
| | | (MPa) | | | | | | | |
| | Ratio of heat-expandable | | 70 | 40 | 65 | 60 | 75 | 55 | 60 |
| | microspheres (wt %) | | | | | | | | |
| | Processing | Kneading temp. (° C.) | 95 | 95 | 80 | 85 | 75 | 100 | 105 |
| | condition | Extrusion performance | Good | Good | Good | Good | Good | Good | Good |
| | | Extrusion temp. (° C.) | 90 | 90 | 70 | 70 | 65 | 100 | 100 |
| | True specific gravity | | 0.95 | 0.92 | 0.94 | 0.94 | 0.94 | 0.94 | 0.92 |
| Foaming molded sheet | Matrix component | | TPO(1) | TPO(1) | TPS | TPS | TPS | TPO(2) | TPO(2) |
| | Molding temp. (° C.) | | 210 | 210 | 160 | 150 | 210 | 210 | 220 |
| | Properties | Expansion ratio (times) | 1.6 | 1.66 | 1.85 | 2.34 | 1.71 | 1.59 | 1.56 |
| | | Specific gravity | 0.55 | 0.53 | 0.48 | 0.38 | 0.52 | 0.56 | 0.57 |
| | | Mean bubble size (μm) | 34 | 36 | 65 | 118 | 102 | 35 | 104 |
| | | Aggregation | none | none | none | none | none | none | none |

| | | Comparative Examples | | | | |
|---|---|---|---|---|---|---|
| | | 1 | 2 | 3 | 4 | 5 |
| Masterbatch | Heat-expandable microspheres | (1) | (1) | (2) | (3) | (4) |

| Organic base | Type | EEA(1) | EEA(1) | EMA(2) | EVA(3) | LDPE(2) |
|---|---|---|---|---|---|---|
| component | MFR (g/10 min) | 250 | 250 | 7 | 2500 | 24 |
| | Melting point | 87 | 87 | 80 | 79 | 106 |
| | Ethylene content (wt %) | 75 | 75 | 75 | 72 | 100 |
| | Tensile fracture stress | 5 | 5 | 9 | 3 | 8 |
| | (MPa) | | | | | |
| Ratio of heat-expandable | | 85 | 25 | 65 | 60 | 60 |
| microspheres (wt %) | | | | | | |
| Processing | Kneading temp. (° C.) | 95 | 95 | 85 | 85 | 105 |
| condition | Extrusion performance | Good | Poor | Good | Poor | Good |
| | Extrusion temp. (° C.) | 90 | — | 80 | — | 100 |

| | | | | | | |
|---|---|---|---|---|---|---|
| | True specific gravity | 0.96 | — | 0.88 | — | 0.92 |
| Foaming molded sheet | Matrix component | TPO(1) | — | TPS | — | TPO(2) |
| | Molding temp. (° C.) | 210 | — | 150 | — | 220 |

| | | | | | | |
|---|---|---|---|---|---|---|
| Properties | Expansion ratio (times) | 1.21 | — | 1.33 | — | 1.25 |
| | Specific gravity | 0.73 | — | 0.67 | — | 0.71 |
| | Mean bubble size (μm) | 39 | — | 61 | | 102 |
| | Aggregation | found | — | found | — | found |

The abbreviations in Tables 1 and 2 are the same as those in Table 3.

TABLE 3

| Abbreviation | Chemical compounds |
|---|---|
| PVP | Polyvinyl pyrolidone |
| EDTA | Ethylenediaminetetraacetic acid tetrasodium salt |
| AN | Acrylonitrile |
| MAN | Methacrylonitrile |
| MAA | Methacrylic acid |
| MMA | Methyl methacrylate |
| TMP | Trimethylolpropane trimethacrylate |
| EDMA | Ethylene glycol dimethacrylate |
| OPP | Di (2-ethylhexyl) peroxydicarbonate (70-wt % |
| | concentration) |
| Isobutane | 2-methyl propane |
| Isopentane | 2-methyl butane |
| Isooctane | 2,2,4-trimethyl pentane |
| EEA (1) | Ethylene-ethyl acrylate copolymer, NUC-6070, supplied |
| | by The Dow Chemical Japan Company |
| EMA (1) | Ethylene-methyl methacrylate copolymer, ACRYFT ™ |
| | CM5021, supplied by Sumitomo Chemical Co., Ltd. |
| EMA (2) | Ethylene-methyl methacrylate copolymer, ACRYFT ™ |
| | WK307, supplied by Sumitomo Chemical Co., Ltd. |
| EVA (1) | Ethylene-vinyl acetate copolymer, Ultrasen 720, supplied |
| | by Tosoh Corporation |
| EVA (2) | Ethylene-vinyl acetate copolymer, Ultrasen 725, supplied |
| | by Tosoh Corporation |
| EVA (3) | Ethylene-vinyl acetate copolymer, Ultrasen 685, supplied |
| | by Tosoh Corporation |
| EMAA(1) | Ethylene-(meth)acrylic acid copolymer resin, NUCREL |
| | N1110Hsupplied by Du Pont- Mitsui Polychemicals |
| LDPE(1) | Low-density polyethylene, Petrosen 353, supplied by Tosoh |
| | Corporation |
| LDPE(2) | Low-density polyethylene, Petrosen 202, supplied by Tosoh |
| | Corporation |
| TPO(1) | Olefin elastomer, EXCELINK 3300B, with the specific |
| | gravity of 0.88 and the Shore A hardness of 29, supplied |
| | by JSR Corporation |
| TPO(2) | Olefin elastomer, Milastomer 8032BS with the specific |
| | gravity of 0.89 and the Shore A hardness of 86, supplied |
| | by Mitsui Chemicals, Inc. |
| TPS | Styrene elastomer, Elastomer AR-SC-30 with the specific |
| | gravity of 0.89 and the Shore A hardness of 26, supplied |
| | by Aronkasei Co., Ltd. |

The masterbatches of Example 1 to 7 exhibited good handling properties and no problems arised in the preparation process owing to the organic base components having a melt flow rate (MFR, g/10 min) higher than 50 and not higher than 2200. The resultant foamed molded articles were lightweight and had a good appearance.

The masterbatch of Comparative Example 1 contained a high ratio of the heat-expandable microspheres. The resultant foamed molded articles did not exhibit high expansion ratio and were not lightweight. Furthermore, the articles had a poor appearance due to aggregation of insufficiently dispersed microspheres.

The masterbatch of Comparative Example 2 contained a low ratio of the heat-expandable microspheres. The masterbatch became sticky in the preparation process to pose poor handling properties and could not be extruded from the compression kneader. This showed that the masterbatch could not be prepared steadily.

The masterbatches of Comparative Examples 3 and 5 contained organic base components having an excessively low melt flow rate. The resultant foamed molded articles did not exhibit a high expansion ratio and were not lightweight. Furthermore, the articles had a poor appearance due to aggregation of insufficiently dispersed microspheres.

The masterbatch of Comparative Example 4 contained an organic base component having an excessively high melt flow rate. The masterbatch became sticky in the preparation process to pose poor handling properties, and could not be extruded from the compression kneader. This showed that the masterbatch could not be prepared steadily.

An extrusion molding machine (with the screw diameter of 50 mm, L/D=30) and an extrusion die for automotive weatherstripping were used. The molding temperature of the machine and die was set at 200° C. and the screw speed was set at 50 rpm. An olefin elastomer (Santoprene 101-73, having a true specific gravity of 0.97 and the Shore A hardness of 78, supplied by Exxon Mobil Corporation) was used for the matrix component of the automotive weatherstripping. The masterbatch of Example 1 was dry blended with the olefin elastomer to prepare a molding composition containing 3 parts by weight of the heat-expandable microspheres to 100 parts by weight of the olefin elastomer. The resultant molding composition was fed to the feed hopper of the extrusion molding machine and processed into a foamed molded article in the form of an automotive weatherstripping (with the expansion ratio of 1.6 times and specific gravity of 0.61).

The foamed molded article contained bubbles having a mean bubble size of 34 μm, and had a good appearance with sufficient surface properties and no aggregation of microspheres so as to be suitable for automotive weatherstripping.

Several foamed molded articles were manufactured in the same manner as mentioned above, except that the masterbatch of Example 1 was replaced by the masterbatches of Examples 2 to 7. The resultant foamed molded articles also had a good appearance with sufficient surface properties and no aggregation of microspheres so as to be suitable for automotive weatherstripping.

### COMPARATIVE EXAMPLE 6

A foamed molded article in the form of an automotive weatherstripping (with the expansion ratio of 1.2 times and specific gravity of 0.81) was manufactured in the same manner as in Example 8, except that the masterbatch was replaced by the masterbatch of Comparative example 1.

The foamed molded article contained bubbles having a mean bubble size of 38 μm, and had a poor appearance with aggregation of microspheres. Thus the article was not suitable for automotive weatherstripping.

Foamed molded articles were manufactured in the same manner as mentioned above except that the masterbatch of Comparative Example 1 was replaced by the masterbatches of Comparative Examples 3 and 5. The foamed molded articles contained aggregation and were not suitable for automotive weatherstripping.

### INDUSTRIAL APPLICABILITY

The masterbatch of the present invention can be blended with a matrix component and manufactured into foamed molded articles by injection molding, extrusion molding and compression molding. The masterbatch blended with a soft matrix component, such as thermoplastic elastomers, can be processed into foamed molded articles having good sealing performance, sound insulation properties, thermal insulation properties, heat shield properties and sound absorption properties. The foamed molded articles are useful sealing materials, and are especially preferable for automotive weatherstrippings and builder weathers trippings.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

1. A masterbatch comprising:
heat-expandable microspheres comprising a thermoplastic resin shell and a thermally vaporizable blowing agent encapsulated therein; and
an organic base component;
wherein the organic base component has a melting point not higher than the expansion-initiation temperature of the heat-expandable microspheres and a melt flow rate (MFR, g/10 min) higher than 50 and not higher than 2200, and
the ratio of the heat-expandable microspheres in the masterbatch ranges from 30 to 80 wt % of the total weight of the heat-expandable microspheres and the organic base component.

2. The masterbatch as claimed in claim 1, wherein the organic base component is an ethylenic polymer, and a ratio of ethylene monomer to all monomers constituting the ethylenic polymer is at least 60 wt %.

3. The masterbatch as claimed in claim 1, wherein the organic base component has a melting point ranging from 45 to 180° C.

4. The masterbatch as claimed in claim 1, wherein the organic base component has a tensile fracture stress not higher than 30 MPa.

5. The masterbatch as claimed in claim 1, wherein the thermoplastic resin is produced by polymerizing a polymerizable component containing a nitrile monomer.

6. The masterbatch as claimed in claim 5, wherein the polymerizable component further comprises a carboxyl-group-containing monomer.

7. The masterbatch as claimed in claim 6, wherein the total weight of the carboxyl-group-containing monomer and the nitrile monomer constitutes at least 50 wt % of the monomer component.

8. The masterbatch as claimed in claim 1, wherein the expansion-initiation temperature of the heat-expandable microsphere is at least 60° C.

9. A molding composition comprising the masterbatch as claimed in claim 1 and a matrix component.

10. The molding composition as claimed in claim 9, wherein the matrix component comprises a thermoplastic elastomer.

11. A foamed molded article manufactured by molding the molding composition as claimed in claim 9.

12. A weatherstripping for an automobile or for a building manufactured by molding the molding composition as claimed in claim 9.
